(19) United States
(12) Patent Application Publication
(10) Pub. No.: US 2014/0056636 A1
(43) Pub. Date: Feb. 27, 2014

(54) DEVICE FOR APPLYING A COMPOSITION TO KERATINOUS FIBERS

(71) Applicant: L'OREAL, Paris (FR)

(72) Inventor: Jean-Louis GUERET, Paris (FR)

(73) Assignee: L'OREAL, Paris (FR)

(21) Appl. No.: 13/967,817

(22) Filed: Aug. 15, 2013

Related U.S. Application Data
(63) Continuation of application No. 13/807,444, now abandoned.
(60) Provisional application No. 61/365,018, filed on Jul. 16, 2010.

(30) Foreign Application Priority Data
Jun. 29, 2010 (FR) 1055222

(51) Int. Cl. A45D 40/26; B29C 37/00

(52) U.S. Cl. CPC A45D 40/262; B29C 37/0053
USPC 401/268; 132/216; 264/299

(57) ABSTRACT

A device for applying a cosmetic composition to keratinous fibers, for example the hair, the eyelashes, or the eyebrows, the device including: a support; and teeth that extend from the support; at least one tooth, or at least half of the teeth, including a longitudinal through slot that extends over a major fraction of the length of the tooth, the slot not opening out at a free end of the tooth, remote from the support.

### CROSS REFERENCE

This application is a continuation of and is based upon and claims the benefit of priority under 35 U.S.C. §120 for U.S. Ser. No. 13/807,444, filed Dec. 28, 2012, the entire contents of which is incorporated herein by reference. U.S. Ser. No. 13/807,444 is a National Stage of PCT/IB11/052815, filed Jun. 27, 2011, which claims priority to U.S. Provisional Application No. 61/365,018, filed Jul. 16, 2010 and claims the benefit of priority under 35 U.S.C. §119 from French Patent Application No. 10 55222, filed Jun. 29, 2010.

The present invention relates to a device for applying a composition, e.g. a hair colorant, to keratinous fibers, in particular the hair, the eyelashes, or the eyebrows.

Patent applications or patents US 2005/0257800, WO 03/041530, JP 2004/024776, WO 2004/082424, DE 10 2004 014342, EP 0 523 460, WO 07/077647, U.S. Pat. No. 5,584,307, FR 2 876 255, and EP 1 382 271 disclose applicators for applying hair colorant to the hair, said applicators including hollow teeth having orifices at their free ends or at their bases or even opening out into intermediate portions of the teeth, so as to dispense the composition onto the hair.

Such applicators may present the drawback of favoring the formation of big bundles of locks of hair, and of favoring the application of composition prior to separating the hair. Thus, the impregnation of the hair with composition may not be very accurate and may not be sufficiently uniform.

Furthermore, when the composition outlet orifices are formed at the bases of the teeth, for example, passing the locks of hair between the teeth may slow down or even prevent dispensing of the composition, and may direct said composition

Thus, known applicators may lead to an unsatisfactory distribution of the composition on the hair, and to poor combing of the locks. Thus, there exists a need to remedy those drawbacks.

Application FR 2 169 154 discloses a comb for grooming the hair, but that is not provided for applying a hair composition to said hair.

Exemplary embodiments of the invention provide a device for applying a cosmetic, makeup, or care-product composition to keratinous fibers, in particular the hair, the eyelashes, or the eyebrows, said device comprising:

a support; and

teeth that extend from the support;

at least one tooth, better at least half of the teeth, including a longitudinal through slot that extends over a major fraction of the length L of the tooth, the slot not opening out at a free end of the tooth, remote from the support.

The term “longitudinal through slot” means a slot that extends along a long axis of the tooth and passes through the entire thickness of said tooth, i.e. opening out on either side of the tooth over a major fraction l of the length of the slot, or even over the entire length of the slot. The slot may open out onto two sides of the tooth, each facing an adjacent tooth, or onto a single side of the tooth facing a single adjacent tooth if the tooth is an end tooth of the row.

The slot extends over a length that is less than the total length L of the teeth measured from the support. In other words, the slot extends over less than the entire length L of the tooth. The slot may extend over more than 60% of the total length L of the tooth measured from the support, or over more than 70%, better over more than 80%, or even over more than 90%. The slot may extend over less than 95% of the total length L of the tooth measured from the support. The slot may open out onto the support. By way of example, the offset between the length L of the tooth and the length l of the slot may lie in the range 0.25 millimeters (mm) to 0.75 mm, e.g. about 0.5 mm.

The invention makes it possible firstly to favor the creation of the finest locks for impregnation, and secondly to obtain satisfactory impregnation of each lock, thereby making it possible to create a better instantaneous effect with the composition, and to decrease the quantities of composition that are required.

The device may include at least two teeth including longitudinal through slots. The device may include at least three teeth including longitudinal through slots, or at least four teeth, better at least five teeth. All of the teeth of the device may include a respective longitudinal through slot as described above. In a variant, some teeth of the device need not have longitudinal through slots. For example, the end teeth of a row of teeth need not have longitudinal through slots.

By means of the invention, the composition may be dispensed in the form of a sheet that is retained by capillarity between the teeth and in the slots of said teeth. Furthermore, the height of the sheet may be adjusted in the device by appropriately selecting the length of the slots in the teeth.

The sheet of composition may advantageously be uninterrupted as a result of the slots being open on each side of the corresponding teeth, thereby enabling the locks that are disposed on either side of the teeth to be impregnated. Thus, each lock may be impregnated on either side simultaneously and on the bottom, thereby favoring satisfactory impregnation of the locks with composition.

The slots may define inside faces of each tooth that are plane, convex, or concave. At least one inside face may define an angle that projects towards the inside of the slot, or, on the contrary, a re-entrant angle, or it may form a longitudinal shoulder.

The slot may have a width e, measured between inside faces of the tooth, that may lie in the range 0.1 mm to 3 mm, or even in the range 0.5 mm to 1.5 mm. The width of the slot may be selected as a function of the composition, e.g. its rheology or the quantity required for application. The width of the slot corresponds to the greatest distance measured between the facing inside faces of the corresponding tooth. It may correspond to the visible width of the slot when the tooth is observed perpendicularly to the plane of the tooth, or it may be greater than the visible width.

The slot may be configured to retain the composition by capillarity, in particular by means of a length that is sufficient and a width that is sufficiently small.

The slot may have a width e, measured between inside faces of the tooth, that is constant along a long axis X of the tooth, over at least half of the length of the slot, or over at least three fourths of the length of the slot, or over more than 90% of the length of the slot, or even more. In other words, the inside faces of the teeth may be parallel to each other. In a variant, they may converge, the slot having a width e that varies along the long axis X of the tooth. In particular, the width of the slot may decrease towards the free end of the teeth. By way of example, the inside faces of the teeth may be bevel shaped.

The device may include flocking over a fraction of its surface, e.g. at the end of at least one tooth, or at the ends of a majority of the teeth, or at the ends of all of the teeth, or over the entire length of a tooth, or over the entire lengths of a plurality of teeth, or over the entire lengths of all of the teeth of the device.

Each of the teeth extending along a long axis X of the tooth, the long axes of two successive teeth may be separated by a pitch lying in the range 0.3 mm to 3 mm. The pitch may be constant or it may vary along the axis of the row. Furthermore, the spacing between two successive teeth, measured at the bases of the teeth at the surface of the support, between the closest-together points of the bases of the teeth, may lie in the range 0.3 mm to 3 mm, better in the range 0.5 mm to 1.3 mm. The spacing may be constant along the axis of the row. In a variant, it may vary, e.g. it may increase or decrease or both along the axis of the row. The spacing between two consecutive teeth may be constant along the long axes of the teeth, over a major fraction of the length of the teeth, or over the entire length of the teeth.

The teeth may be arranged in at least one row of teeth that extend from the support. The row may optionally be a single row. In one row, the teeth may be offset relative to one another, or, in a variant, they may be in alignment.

The long axes of the teeth of the row, or of all of the teeth of the device, may be parallel to one another.

The teeth may have thickness lying in the range 0.3 mm to 3 mm, or in the range 0.3 mm to 1.5 mm, e.g. about 0.8 mm. The thickness of a tooth is measured along the axis Y of the row to which it forms a part. In the invention, the teeth may be relatively fine, thus enabling the creation of a greater number of finer locks of hair, thereby favoring the application of the composition. The teeth may be of a thickness that is constant along their long axes.

The teeth may preferably be of cross-section that is flat. A ratio of their width to their thickness may lie in the range 2 to 8. The cross-section of a tooth perpendicular to its long axis may define a major axis of the cross-section that may extend perpendicularly to the axis of the row.

A ratio of the width of the tooth to the width e of the slot may lie in the range 1.5 to 8, or even more. The width of a tooth is measured perpendicularly to its thickness, and perpendicularly to the axis Y of the row. The tooth may be longer than it is wide, indeed 1.5 times longer than it is wide, better at least two times longer than it is wide, or even more.

At least two teeth may be identical. At least three teeth may be identical. All of the teeth may be identical, except for the two end teeth. Still in a variant, all of the teeth may be identical, including the end teeth.

In a variant, at least two teeth may be of shapes that are different. For example, the teeth may be of different lengths. By way of example, the length of the teeth may increase and then decrease along the axis Y of the row of teeth. In a variant, the length of the teeth may decrease and then increase along the axis Y of the row of teeth. Still in a variant, the length of the teeth may be constant over a segment of the row of teeth.

The slots of at least two teeth may have lengths that are different. In a variant, the slots of all of the teeth may have lengths that are different. By way of example, the length of the slots may increase along the longitudinal axis Y of the row, and then decrease, or, on the contrary, they may decrease and then increase.

The teeth may be extended over the support by splines, forming between them longitudinal channels that make it possible both to retain composition and to separate the hair into locks. Between the splines, the support is preferably solid. The splines may project by more than 0.5 mm. The splines may slope relative to a mid-plane of the device, which mid-plane contains the axis of the row and the long axes of the teeth.

At one end, the teeth may be of shape that is tapering, favoring the insertion of the teeth into the hair. The teeth may be of shape that is rectilinear or undulating. The teeth may be of shape that is alternating along the longitudinal axis of the row. At least one tooth, or a majority of the teeth, or all of the teeth, may include a portion in relief, making it possible to retain composition by capillarity.

The device may further include at least one dispenser orifice for dispensing the composition supplied by a supply of composition, said orifice passing through the support and opening out at the base of the slot. Thus, the dispenser orifice may open out firstly into the slot(s), and secondly to the other side of the support. The dispenser orifice may comprise a transverse slot that is formed in the support, perpendicularly to the slot(s) formed in the teeth. The transverse slot may be of shape that is oblong, rectilinear, or undulating, for example. The dispenser orifice may be narrower or wider than the slot(s) of the teeth. It may open out into the slots only, or also outside of the slots. The dispenser orifice may extend between the teeth. The dispenser orifice may be common to a plurality of teeth. In a variant, the dispenser orifice may comprise a plurality of orifices, each orifice opening out at the base of a slot formed in a tooth. By way of example, each of said orifices may be of shape that is circular. No element need be engaged in the slots and/or in the orifices, in particular no porous element.

In a variant, the device need not have a composition dispenser orifice.

The device may define at least one plane of symmetry. By way of example, the device may define a plane of symmetry that extends perpendicularly to an axis of a row of teeth.

In addition, and by way of example, each of the teeth may be symmetrical about a plane of symmetry of the device. By way of example, the plane of symmetry may extend along an axis Y of a row of teeth.

In a variant, the device need not be symmetrical about an axis Y of a row of teeth. By way of example, the teeth may be asymmetrical, e.g. including two tooth portions on either side of the slot, the two portions not being symmetrical. By way of example, one of the tooth portions may be wider than the other. In a variant, the two portions may be identical. Thus, the slot may be centered or off-center relative to the corresponding tooth.

The row of teeth may be centered relative to the support. In a variant, the row of teeth may be offset relative to a plane of symmetry of the support.

The support may define an inside space constituting a mixing chamber for mixing the composition.

The device may include an open/closed closure device, e.g. movable axially and/or in rotation.

The support may include fastener means for fastening to a container, e.g. a screw thread or an annular bead making it possible to snap-fasten the device on a container.

In a variant, the support may be secured to a container. By way of example, the container may be a bottle or a flexible tube that is molded integrally with the support, and that may be filled with composition via its bottom end and then heat sealed.

Still in a variant, the device may include a handle that may be fitted on the support, e.g. snap-fastened thereon, or that is formed integrally therewith, e.g. molded with the support or over-molded thereon. The handle may be of shape that is tapering, making it possible to gather together a lock of hair. In variant exemplary embodiments, the handle may include capillary grooves, making it possible to retain composition by capillarity. The grooves may be transverse to a longitudinal axis of the handle. The may be situated on the handle in the proximity of the support and of the teeth of the device.

In a variant, the container need not be fastened to the device. By way of example, the container may be a bowl in which the device may be dipped and wiped against the edges of the bowl.

The invention also provides an assembly comprising at least one device as defined above, and at least one container containing a composition. The assembly may comprise a second container containing a second composition. The first and second compositions may be for mixing together before application, outside the device or inside said device.

The device is configured to be dipped in the container so as to be loaded with composition by capillarity effect. The device may be wiped while being removed from the container, e.g. against a rim of said container.

By way of example, the container may be a flexible or deformable container, such as a tube, that it suffices to squeeze in order to cause the composition to flow through an internal channel, and to be dispensed via the dispenser orifice.

As a function of the length of the longitudinal slot relative to the remainder of the device, and of the force exerted on the container, the sheet of composition may reach different heights.

The composition may be sucked back into the container via the dispenser orifice, e.g. when the pressure applied to the container e.g. a flexible tube, is relaxed.

The invention also provides a method of manufacturing a device as defined above, wherein in order to mold the device, use is made of a first mold portion and a second mold portion including a projecting portion that may be beveled. The projecting portion makes it possible to form the slot(s) in the teeth.

The invention can be better understood on reading the following detailed description of embodiments of the invention, and on examining the accompanying drawings, in which:

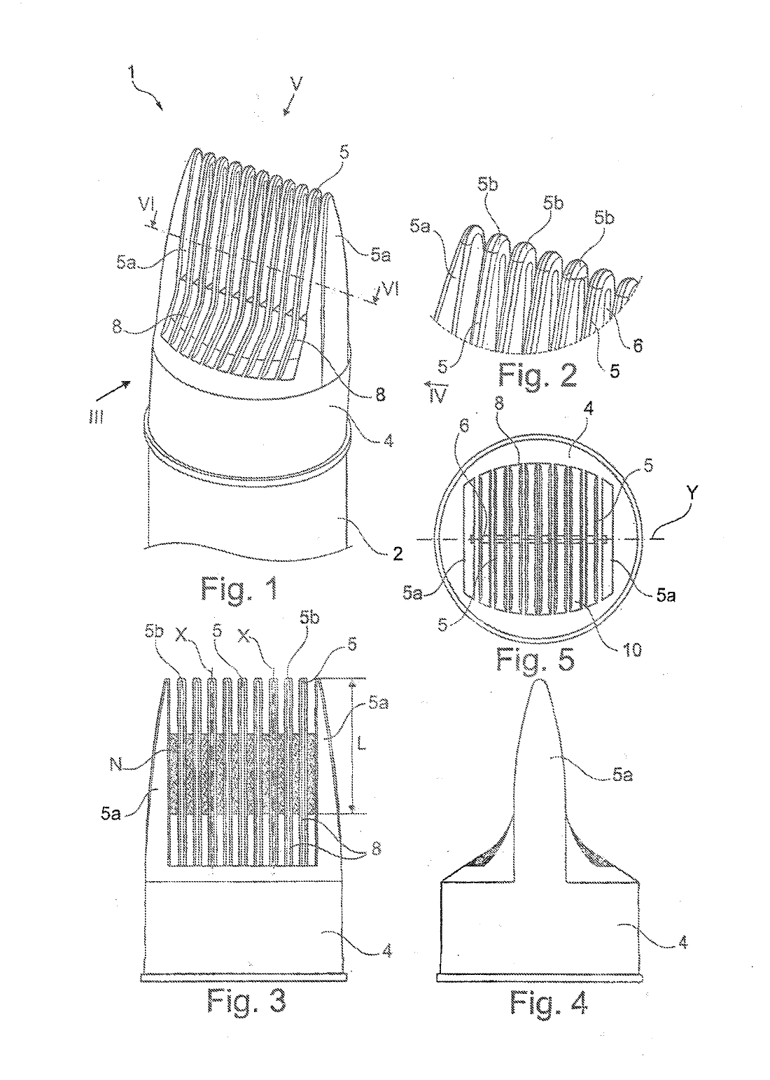

FIG. 1 is a diagrammatic and fragmentary perspective view of an assembly including a device of the invention;

FIG. 2 is a view of a detail of the FIG. 1 assembly;

FIG. 3 is a view as seen looking along arrow III in the FIG. 1 device;

FIG. 4 is a view as seen looking along arrow IV in the FIG. 1 device;

FIG. 5 is a view as seen looking along arrow V in the FIG. 1 device;

FIG. 6 is a section on VI-VI in the FIG. 1 device;

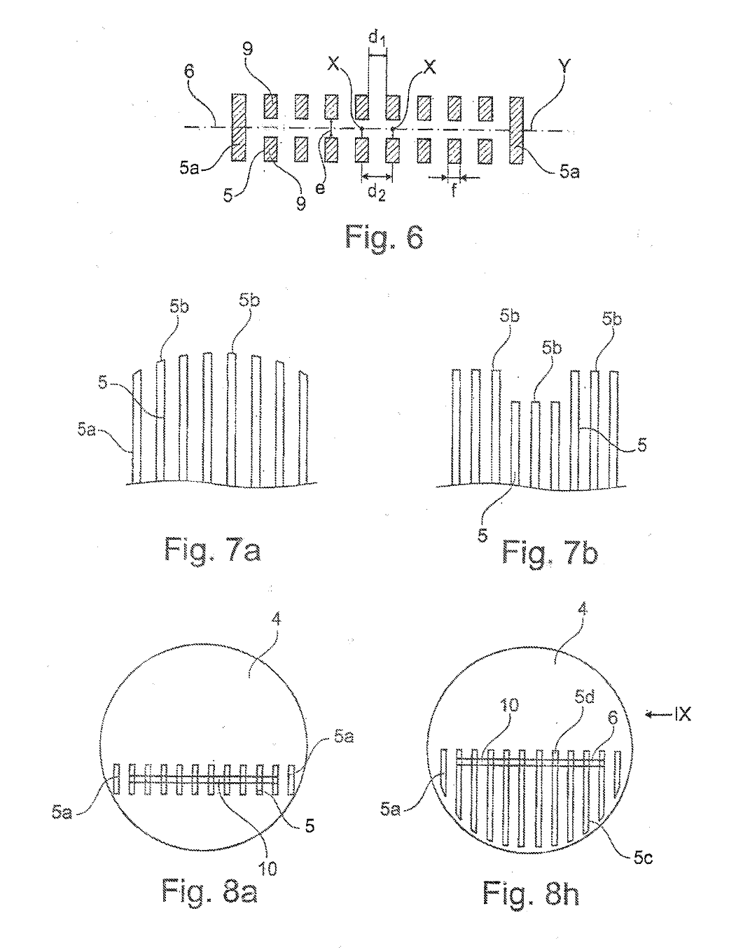

FIGS. 7a and 7b are diagrammatic and fragmentary views similar to FIG. 3 showing variant embodiments of the invention;

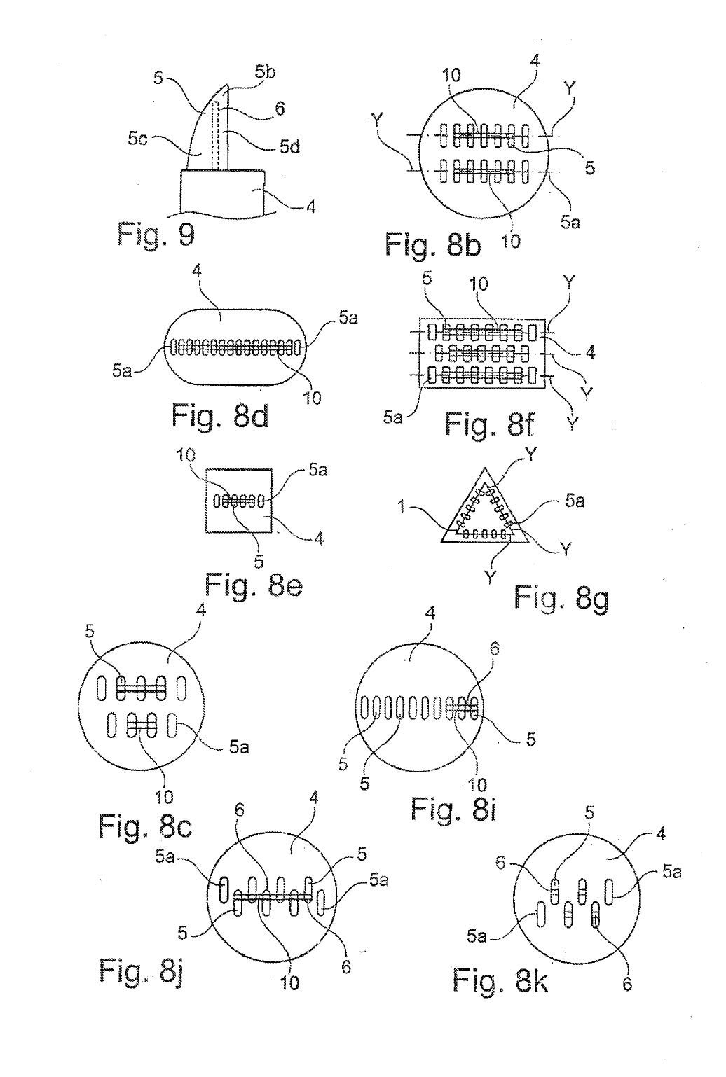

FIGS. 8a to 8k are diagrammatic and fragmentary views similar to FIG. 5 showing variant embodiments of the invention;

FIG. 9 is a view as seen looking along arrow IX in the FIG. 8h embodiment;

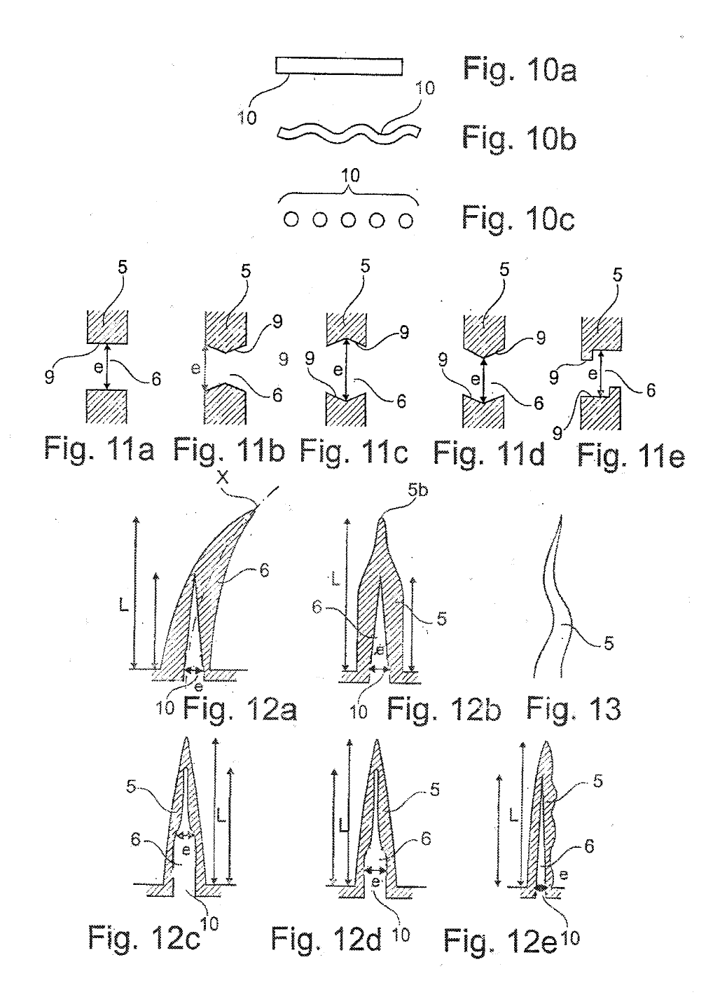

FIGS. 10a to 10c show variant embodiments of dispenser orifices for dispensing the composition;

FIGS. 11a to 11e show variant embodiments of cross-section of teeth;

FIGS. 12a to 12e are diagrammatic and fragmentary longitudinal sections of variant embodiments of teeth;

FIG. 13 is a side view of an undulating tooth;

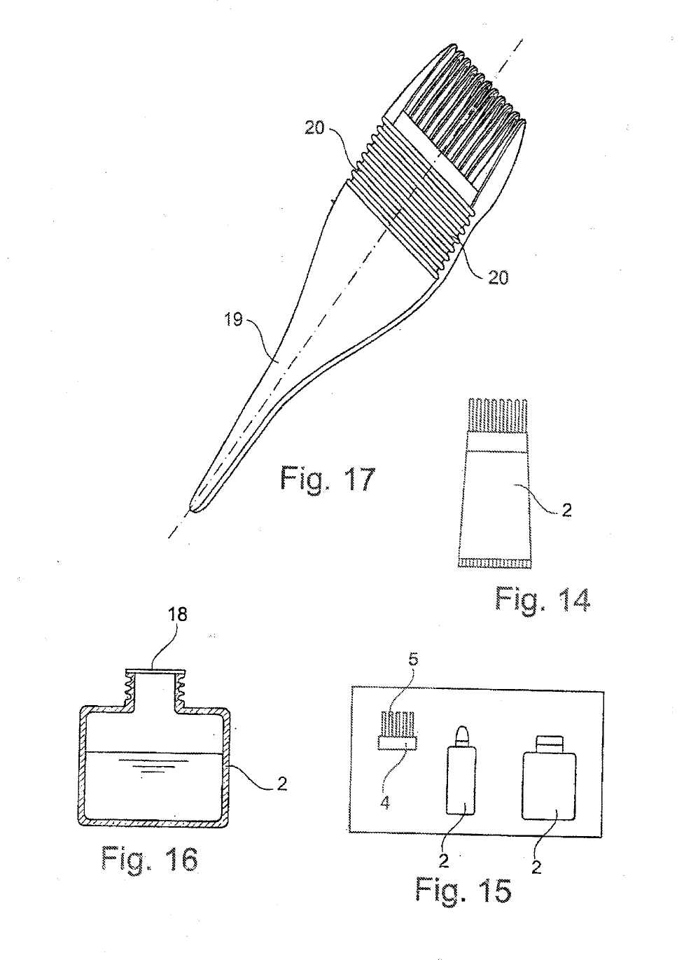

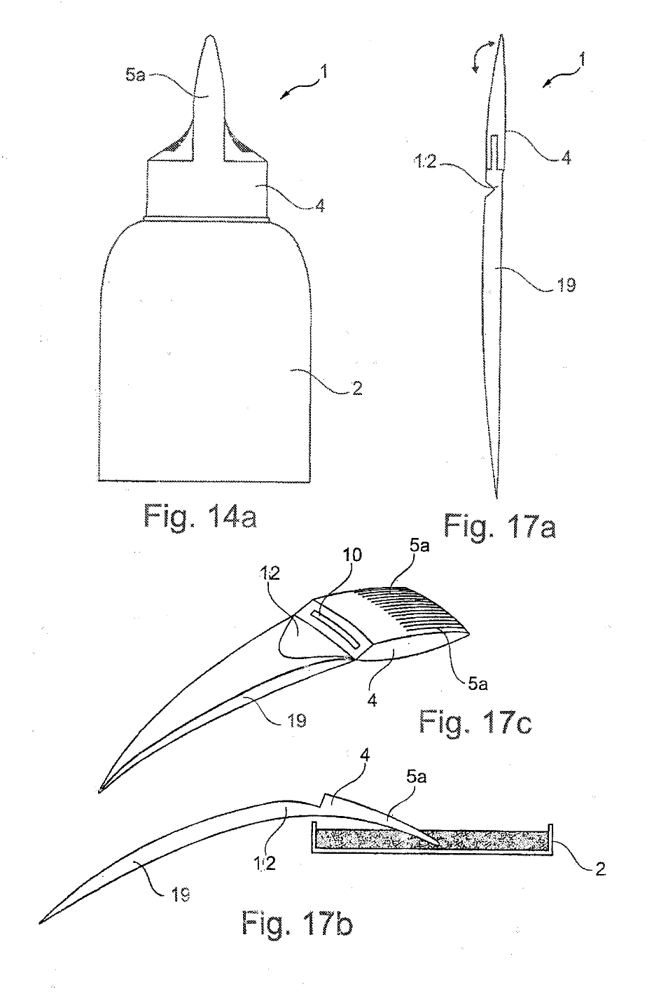

FIGS. 14, 14a, 15, 17, and 17a to 17c are diagrammatic and fragmentary perspective or side views of assemblies of the invention;

FIG. 16 is a longitudinal section of an assembly of the invention;

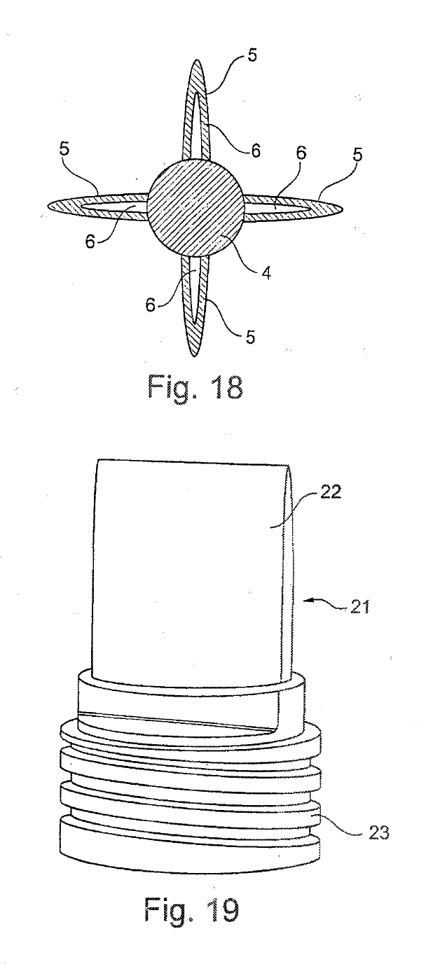

FIG. 18 is a cross-section of a variant embodiment of the device of the invention; and

FIG. 19 is a diagrammatic and fragmentary perspective view of a mold portion for molding a device of the invention.

FIGS. 1 to 6 show an assembly for applying a cosmetic, makeup, or care-product composition to keratinous fibers, in particular the hair, said assembly comprising a container 2, shown diagrammatically, on which there is fastened an applicator device for applying composition, said applicator device comprising a support 4 and teeth 5 that extend from the support 4 in a row of teeth.

The row of teeth includes end teeth 5a that do not have slots, while each of the other teeth 5 includes a longitudinal through slot 6 that extends from the support, over a major fraction of the length L of the tooth, measured from the support. The slots 6 do not open out at free ends 5b of the teeth, remote from the support, i.e. the slots 6 extend over a length l that is less than the length L of the tooth.

The slots 6 are through slots, i.e. each of them opens out on either side of the corresponding tooth, facing the two teeth that are adjacent to the corresponding tooth.

The end teeth 5a of the row are preferably solid, not having slots, but it would not be beyond the ambit of the present invention for them likewise to include slots.

FIG. 6 shows the device in cross-section, with the teeth being intersected in such a manner as to show the width e of the slots, measured between the inside faces 9 of each tooth, and the spacing d₁ between two successive teeth. The spacing d₁ is measured at the bases of the teeth at the surface of the support, between the closest-together points of the bases of the teeth. It is also possible to measure the spacing known as pitch d₂ between the long axes X of two successive teeth. Finally, in FIG. 6, it is possible to observe the thickness f of a tooth measured along the axis Y of the row.

The slots 6 formed in the teeth 5 are supplied with composition by means of a composition dispenser orifice 10 that is formed in the support 4 at the bases of the slots 6 of the teeth 5. The dispenser orifice 10 opens out into the support on the side remote from the teeth, in fluid-flow communication with the inside of the container 2 in which the composition is stored.

While the composition is being dispensed, a capillary sheet N of composition, shown in FIG. 3, is created in the slots 6 and between the teeth 5, having a height that may be selected as a function firstly of the length of the teeth 5, of the length of the slots 6, of the position of the dispenser orifice 10, and secondly of the force that may be exerted on the container 2 by the user for forcing the composition P out from the container 2 via the dispenser orifice 10. The formation of the capillary sheet is also improved when the consecutive slots of a row are in alignment.

The teeth 5 are extended over the support 4 by splines 8 that make it possible to retain composition between them by capillarity, and that make it possible to smooth the locks of hair that are formed between the teeth 5.

The device, in particular the support 4 and the teeth 5, may be made out of a material that may be rigid or flexible. By way of example, the material may be a thermoplastic material such as polyethylene (PE), polystyrene (PS), polyamide (PA), polyoxymethylene (POM), polypropylene (PP), or a thermoplastic elastomer material such as styrene-isoprene-styrene (SIS), styrene-ethylene-butylene-styrene (SEBS), polyvinyl chloride (PVC), ethyl vinyl acetate (EVA), ethylene-propylene terpolymer rubber (EPDM), polyurethane (PU), this list not being limiting.

By way of example, the teeth may be made out of a material that is different from the material out of which the support is made, or, in a variant, they may be made out of the same material.

In the embodiment described, the ends 5b of the teeth 5a and 5 are all in alignment, but it would not be beyond the ambit of the present invention for this to be otherwise. By way of example, FIG. 7a shows a variant embodiment in which the free ends 5b of the teeth 5 and 5a are situated on a curved line that is outwardly convex. Naturally, they could be situated on a curved line that is concave, for example, or they could present an undulating shape. FIG. 7b shows an embodiment in which they are situated on a line that forms a notch.

In the embodiment described above, the teeth are arranged in a single row that is central relative to the support 4, but, by way of example, it would not be beyond the ambit of the present invention for the row of teeth to be off-center relative to the support, as shown in FIG. 8a. By way of example, the teeth of the row may be offset relative to one another, as shown in FIG. 8j.

Still in a variant, the teeth may be arranged in two rows of teeth, as shown in FIG. 8b. In these exemplary embodiments, two teeth, i.e. one from each of the two rows, are in alignment. It would not be beyond the ambit of the present invention for this to be otherwise. By way of example, FIG. 8c shows an embodiment in which two teeth, i.e. one from each of the two rows, are offset relative to each other.

As shown above, the slots of the teeth may optionally be in alignment, e.g. being offset relative to one another, as shown in FIG. 8k.

In the embodiments described above, the support 4 is of generally circular shape, but it would not be beyond the ambit of the present invention for this to be otherwise. By way of example, FIG. 8d shows a support of generally oval shape. It may also be of generally polygonal shape, e.g. square, as shown in FIG. 8e, or rectangular, as shown in FIG. 8f, or even triangular, as shown in FIG. 8g.

These embodiments also show the possibility of arranging the teeth and the rows of teeth in different ways. In FIG. 8f, the device includes three rows of teeth that extend along axes that are parallel to one another, the teeth of two adjacent rows being offset relative to one another.

FIG. 8g shows an embodiment that includes three rows of teeth that are arranged in a triangle, each of the rows of teeth extending along an axis Y that is parallel to an edge of the support.

In all of the embodiments described above, each tooth is symmetrical about a plane of symmetry that extends along the longitudinal axis Y of the row, but it would not be beyond the ambit of the present invention for this to be otherwise.

By way of example, in FIG. 8h and in side view in FIG. 9, an embodiment is shown in which the teeth include two non-symmetrical tooth portions 5c and 5d, with the slot 6 not being central relative to the tooth. In these exemplary embodiments, the teeth extend at their bases over a half-portion of the support.

In all of the embodiments described above, the dispenser orifice 10 extends over almost the entire length of the support, in such a manner as to enable composition to be dispensed into all of the slots 6 of all of the teeth 5, except for the end teeth 5a of the row.

Naturally, it would not be beyond the ambit of the present invention for this to be otherwise, and for the dispenser orifice 10 to extend over less than a major fraction of the length of the row.

By way of example, FIG. 8i shows an embodiment in which only three teeth include slots, the orifice opening out only to the bases of the three teeth so as to supply the slots of said teeth with composition, the other teeth not having slots and not being supplied with composition. Composition may be deposited on the other teeth by coming from the teeth that include slots via which the composition is dispensed.

In the embodiments described above, the dispenser orifice 10 is of elongate rectangular shape, as shown in FIG. 10a, but it would not be beyond the ambit of the present invention for this to be otherwise. By way of example, it could be of undulating shape, as shown in FIG. 10b, or it could even comprise a plurality of individual orifices, each opening out at the base of a slot 6, as shown in FIG. 10c.

In the embodiments described above, the inside faces 9 of the teeth, defining the slots 6, are plane, as shown in FIG. 11a. Naturally, it would not be beyond the ambit of the present invention for this to be otherwise, and for the inside faces to be non-plane. By way of example, they may be convex towards the inside of the slot, as shown in FIG. 11b, or concave, as shown in FIG. 11c, or one may be concave and the other convex, as shown in FIG. 11d, their shapes being optionally complementary. Still in a variant, each of the faces may form a longitudinal shoulder, as shown in FIG. 11e, the longitudinal shoulders being of optionally complementary shape, e.g. being offset relative to each other, as shown in FIG. 11e.

The teeth 5 may be non-symmetrical relative to their long axis X, e.g. being curved, as shown in FIG. 12a. In the embodiment described, the slot 6 is not curved.

The tooth 5 may include a portion that is tapering towards its free end 5b, e.g. in such a manner as to favor the insertion of the tooth into the hair, and to favor the creation of locks of hair.

The width e of a slot 6 may decrease towards the free end of the tooth in geometrically similar manner, as shown in FIGS. 12a and 12b, or, in a variant, not in geometrically similar manner, as shown in FIGS. 12c and 12d. By way of example, the inside faces 9 of the tooth may define a shoulder where the width of the slot decreases suddenly, the shoulder possibly being disposed at different heights up the tooth, as shown in FIGS. 12c and 12d.

In the embodiment shown in FIG. 13, the tooth 5 is of generally undulating shape.

By way of example, the container 2 may be a flexible tube, as shown in FIG. 14, or a bottle, as shown in FIG. 14a, being fastened to the device by screw-fastening or by snap-fastening or even by adhesive, or being molded integrally with said device by molding or by over-molding.

The device may be configured to co-operate with the container in two positions, namely a closed position in which the device closes the container, preventing the composition from being dispensed, and a dispensing position in which the composition can be dispensed. In use, it is possible to pass from one position to the other. The device may include a closure pin for this purpose. It is possible to turn the device relative to the container so as to pass from one position to the other.

In a variant, it is possible to provide the user with a device that is not fastened onto a container, and to provide one or more containers 2 independently of the device, the device being for fastening onto a container by the user, e.g. after mixing together two compositions that are stored separately in the two containers, as shown in FIG. 15.

Still in a variant, it is possible to provide a plurality of devices with one or more containers, the devices possibly being different. By way of example, they may differ by the length of the row, making it possible to color locks of different widths.

By way of example, at least one of the containers may be closed by means of a film 18 before being opened, as shown in FIG. 16.

Still in a variant, the device need not be associated with a container. By way of example, it may include a handle 19 that may present a shape that is tapering, so as to make it possible to form locks of hair. The device may be molded integrally with the handle 19, as shown in FIGS. 17b and 17c, or it may be fitted onto said handle, as shown in FIGS. 17 and 17a. By way of example, the handle 19 may include transverse grooves 20 that are arranged in the proximity of the device at one end of the handle, enabling the device to be gripped better in the hand, as shown in FIG. 17. By way of example, the device may by used by being dipped into a reservoir of composition, with composition being introduced by capillarity between the teeth and into the slots of the teeth, thereby constituting supplies of composition and prolonging the application action by decreasing the required composition-reloading frequency.

In a variant, the handle 19 may include a flexible portion 12, as shown in FIG. 17a. The flexible portion may enable the orientation of the device to be modified relative to the user's hand holding the handle. The flexible portion may result from a narrowing of the cross-section of the handle. It may include a film hinge. The flexible portion may separate two portions, forming a non-zero angle between them.

By way of example, the flexible portion makes it possible to perform application gently. The handle may be made out of a thermoplastic material such as PP or PS. The flexible portion and/or the device may be made out of elastomer.

In the embodiment shown in FIGS. 17b and 17c, the handle and the device are molded as a single part that is curved in shape so as to enable the user to take the composition from a container 2, e.g. a dish-shaped container. The device may be wiped against the rim of the container 2. The handle 19 may be perforated. As shown, the handle 19 may include a flexible portion 12, or it need not include a flexible portion.

In the embodiment in FIGS. 17b and 17c, the fact that the handle 19 is not in register with the orifice 10, means that the mold may be passed and introduced here so as to form the slots.

The device need not have a dispenser orifice for dispensing the composition, and it need not have a reservoir of composition.

By way of example, FIG. 18 shows a cross-section of a mascara brush including teeth 5 that are arranged in rows on a support, each tooth including a slot 6. The brush may be loaded with composition by dipping it into a container containing the composition. The container may be fitted with a wiper member for wiping the brush.

The device of the invention may be molded using a first mold portion and a second mold portion, the second mold portion 21 including a projecting portion 22 that may be beveled in such a manner as to mold the slots 6 into the device. By way of example, FIG. 19 shows a second mold portion 21 that is suitable for molding the device in FIGS. 1 to 6. The projecting portion 22 is of beveled shape, making it possible to form both a plurality of slots 6 in the teeth 5, and a longitudinal dispenser orifice 10. Furthermore, the mold portion includes a screw thread 23 making it possible to form a corresponding screw thread in the support 4.

Naturally, the invention is not limited to the above-described embodiments, the characteristics of which may be combined together within variants not shown.

The expression “comprising a” should be understood as being synonymous with “comprising at least one”, and “lying in the range” should be construed as including the limits of the range, unless specified to the contrary.

1. (canceled)

2. A device for applying a cosmetic composition to keratinous fibers, or to hair, eyelashes, or eyebrows, the device comprising:
a support; and
teeth that extend from the support;
at least one tooth, or at least half of the teeth, including a longitudinal through slot that extends over a major fraction of the length of the tooth, the slot not opening out at a free end of the tooth, remote from the support.

3. A device according to claim 2, wherein the slot defines inside faces of the tooth that are plane, convex, or concave.

4. A device according to claim 2, wherein the slot has a width, measured between inside faces of the tooth, lying in a range of 0.1 mm to 3 mm.

5. A device according to claim 2, wherein the slot has a width, measured between inside faces of the tooth, that is constant along a long axis of the tooth, over at least half of the length of the slot.

6. A device according to claim 2, wherein the slot has a width, measured between inside faces of the tooth, that varies along a long axis of the tooth.

7. A device according to claim 2, each of the teeth extending along a long axis of the tooth, the long axes of two successive teeth being separated by a pitch lying in a range of 0.3 mm to 3 mm.

8. A device according to claim 2, spacing between two successive teeth, measured at a base of the teeth at a surface of the support, between closest-together points of the bases of the teeth, lies in a range of 0.3 mm to 3 mm.

9. A device according to claim 2, wherein the teeth have thickness lying in a range of 0.3 mm to 3 mm.

10. A device according to claim 2, wherein the teeth are arranged in at least one row of teeth that extend from the support.

11. A device according to claim 10, wherein the row includes end teeth that do not have slots.

12. A device according to claim 2, further comprising at least one dispenser orifice for dispensing the composition, the orifice passing through the support and opening out at the base of the slot.

13. A device according to claim 2, wherein the support includes fastener means for fastening to a container.

14. A device according to claim 2, further comprising a handle that is fitted on the support or that is formed integrally with the support.

15. An assembly comprising:
at least one device according to claim 2; and
at least one container containing a composition.

16. A method of manufacturing a device according to claim 2, wherein to mold the device, use is made of a first mold portion and a second mold portion including a beveled projecting portion.
